(19) United States
(12) Patent Application Publication
(10) Pub. No.: US 2024/0168160 A1
(43) Pub. Date: May 23, 2024

(54) ANGLE SENSING DEVICE AND ANGLE SENSING SYSTEM

(71) Applicant: ASUSTEK COMPUTER INC., TAIPEI (TW)

(72) Inventors: Hann Shiang YANG, Taipei (TW); Kaiyu HSU, Taipei (TW); Cheng Wei CHEN, Taipei (TW)

(21) Appl. No.: 18/191,635

(22) Filed: Mar. 28, 2023

(30) Foreign Application Priority Data
Nov. 18, 2022 (TW) 111144210

(51) Int. Cl. G01S 17/42; G01S 17/04

(52) U.S. Cl. CPC G01S 17/42; G01S 17/04

(57) ABSTRACT

An angle sensing device includes a base, a rotation shaft, a detected target, and a proximity sensor. The rotation shaft is rotatably arranged on the base, and includes a side surface and a virtual axis. The detected target is arranged on the side surface, and an outer contour of a cross section of the detected target along a radial direction of the rotation shaft includes a first detected position and a second detected position, where a distance of the first detected position with respect to the virtual axis is different from that of the second detected position. The proximity sensor is fixedly arranged on the base and faces the detected target. When the detected target rotates together with the rotation shaft, the proximity sensor emits light toward the detected target and detects reflected light from the outer contour of the detected target to generate measurement data.

### CROSS-REFERENCE TO RELATED APPLICATION

This application claims the priority benefit of Taiwan application serial No. 111144210, filed on Nov. 18, 2022. The entirety of the above-mentioned patent application is hereby incorporated by reference herein and made a part of the specification.

### BACKGROUND OF THE INVENTION

### Field of the Invention

The disclosure relates to an angle sensing device, and in particular, to an optical angle sensing device applicable to an electronic device.

### Description of the Related Art

Conventional angle sensors are mainly classified into two categories:
inductive angle sensor and optical angle sensor. The inductive angle sensor is limited by its physical structure and sensing principle, and is easily affected by external magnetic interference to affect the feedback control accuracy. The conventional optical angle sensor has the problem of poor sensing accuracy.

### BRIEF SUMMARY OF THE INVENTION

The disclosure provides an angle sensing device, including a base, a rotation shaft, a detected target, and a proximity sensor. The rotation shaft is rotatably arranged on the base, and the rotation shaft includes a side surface and a virtual axis. The detected target is arranged on the side surface, and an outer contour of a cross section of the detected target along a radial direction of the rotation shaft includes a first detected position and a second detected position, where a distance of the first detected position with respect to the virtual axis is different from that of the second detected position with respect to the virtual axis. The proximity sensor is fixedly arranged on the base and faces the detected target. When the detected target rotates together with the rotation shaft, the proximity sensor emits light toward the detected target and detects reflected light from the outer contour of the detected target to generate measurement data.

The disclosure also provides an angle sensing system, including an angle sensing device and a processing unit. The angle sensing device includes a base, a rotation shaft, a detected target, and a proximity sensor. The rotation shaft is rotatably arranged on the base, and the rotation shaft includes a side surface and a virtual axis. The detected target is arranged on the side surface, and an outer contour of a cross section of the detected target along a radial direction of the rotation shaft includes a first detected position and a second detected position, where a distance of the first detected position with respect to the virtual axis is different from that of the second detected position with respect to the virtual axis. The proximity sensor is fixedly arranged on the base and faces the detected target. When the detected target rotates together with the rotation shaft, the proximity sensor emits light toward the detected target and detects reflected light from the outer contour of the detected target to generate measurement data. The processing unit is electrically coupled to the angle sensing device for obtaining an angle value through conversion according to the measurement data generated by the proximity sensor.

The angle sensing device provided in the disclosure achieves high-accuracy measurement in a small space, and overcomes the fact that the conventional inductive angle sensor is easily affected by external magnetic interference to affect the feedback control accuracy, and the optical angle sensor has the problem of poor sensing accuracy.

### BRIEF DESCRIPTION OF THE DRAWINGS

FIG. 1 is a schematic diagram of an angle sensing device according to an embodiment of the disclosure;

FIG. 2 is a waveform graph showing an output of a proximity sensor and a feature curve of a distance between the proximity sensor and a detected target;

FIG. 3A is a schematic three-dimensional diagram of a detected target according to an embodiment of the disclosure;

FIG. 3B is a simulation result of a proximity sensor detecting the detected target in FIG. 3A at different angle positions;

FIG. 4 is a schematic three-dimensional diagram of an angle sensing device according to another embodiment of the disclosure;

FIG. 5 is a schematic diagram of an angle sensing device according to still another embodiment of the disclosure;

FIG. 6A is a schematic diagram of a detected target according to another embodiment of the disclosure;

FIG. 6B is a simulation result of a proximity sensor detecting the detected target in FIG. 6A at different angle positions;

FIG. 7A is a schematic three-dimensional diagram of a detected target according to still another embodiment of the disclosure; and

FIG. 7B is a simulation result of a proximity sensor detecting the detected target in FIG. 7A at different angle positions.

### DETAILED DESCRIPTION OF THE EMBODIMENTS

More detailed descriptions of specific embodiments of the disclosure are provided below with reference to the schematic diagrams. The features and advantages of the disclosure are described more clearly according to the following description and claims. It should be noted that all of the drawings use very simplified forms and imprecise proportions, only being used for assisting in conveniently and clearly explaining the objective of the embodiments of the disclosure.

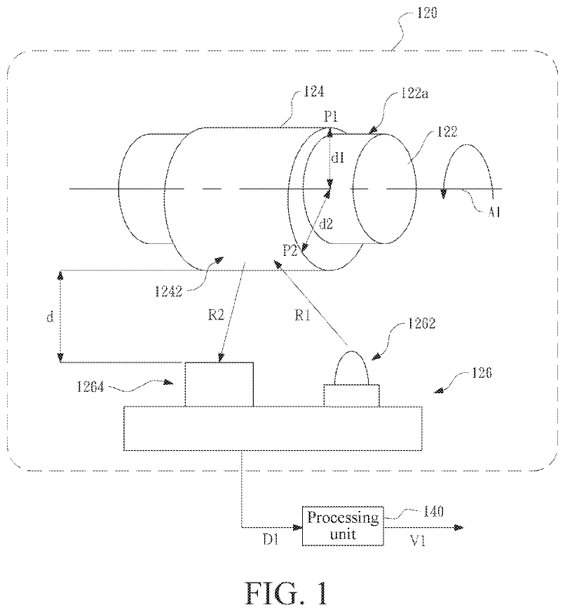

FIG. 1 is a schematic diagram of an angle sensing device 120 according to an embodiment of this application.

As shown in the figure, the angle sensing device 120 is adapted to be coupled to a processing unit 140, where the processing unit 140 obtains an angle value V1 through conversion according to measurement data D1 detected by the angle sensing device 120. The angle sensing device 120 and the processing unit 140 compose an angle sensing system.

The angle sensing device 120 includes a rotation shaft 122, a detected target 124, and a proximity sensor 126. The rotation shaft 122 is rotatably arranged on a base (not shown), and includes a side surface 122a and a virtual axis A1.

The detected target 124 is formed on the side surface 122a of the rotation shaft 122, and rotates together with the rotation shaft 122. An outer contour of a cross section of the detected target 124 along a radial direction of the rotation shaft 122 includes a first detected position P1 and a second detected position P2, where a distance d1 of the first detected position P1 with respect to the virtual axis A1 is different from a distance d2 of the second detected position P2 with respect to the virtual axis V1. More detailed descriptions are provided in subsequent paragraphs for the specific structure of the detected target 124.

The proximity sensor 126 is fixedly arranged on the base, and has a detection direction facing the rotation shaft 122, to detect the detected target 124 to generate measurement data D1.

The processing unit 140 is electrically coupled to the angle sensing device 120, to obtain an angle value V1 through conversion according to the measurement data D1. In an embodiment, the processing unit 140 is a microcontroller or a microprocessor. In an embodiment, the processing unit 140 learns through a neural network to obtain correction parameters to correct parameters used by the processing unit 140 for the conversion operation of the processing unit 140, so as to improve sensing accuracy of the angle sensing device 120 in the disclosure.

Description is made below for the operation principle of the angle sensing device 120. As shown in the figure, there is a distance d between the proximity sensor 126 and a measurement surface 1242 of the detected target 124. The proximity sensor 126 includes a light source 1262 and an optical receiver 1264, where the light source 1262 emits light R1 toward the detected target 124, the optical receiver 1264 receives reflected light R2 from the detected target 124, and generates the measurement data D1 according to a light intensity value of the reflected light R2.

A magnitude of the light intensity value received by the proximity sensor 126 is related to the distance d between the proximity sensor 126 and the measurement surface 1242 of the detected target 124. In a case of a known external shape of the detected target 124, by analyzing the measurement data D1, an orientation of the detected target 124 is determined, and then an angle position of the rotation shaft 122 is determined, so as to detect a rotation angle in an optical manner.

Through the aforementioned features, the angle sensing device 120 of this embodiment not only detects a current absolute angle value of the rotation shaft 122, but also calculates the rotation angle of the rotation shaft 122 by detecting the angle position before and after rotation of the rotation shaft 122.

In an embodiment, the light source 1262 of the proximity sensor 126 is an infrared light source, and the optical receiver 1264 is an infrared optical receiver. The light source 1262 and the optical receiver 1264 are arranged along a vertical direction, and the vertical direction is parallel to the virtual axis A1 of the rotation shaft 122.

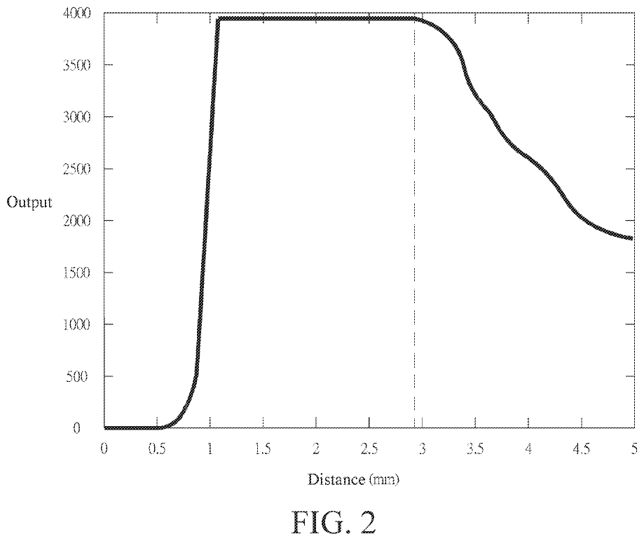

FIG. 2 is a waveform graph showing an output of a proximity sensor 126 and a feature curve of a distance between the proximity sensor and a detected target 124. A horizontal axis in the figure refers to the distance between the proximity sensor 126 and the detected target 124 (as the distance d shown in FIG. 1). A vertical axis represents the output of the proximity sensor 126. Values in the figure do not have units, but only express relative magnitudes.

Generally, an operating range of a conventional proximity sensor 126 is a region where the distance between the proximity sensor 126 and the detected target 124 is greater than 3 mm. In contrast, in the disclosure, a region of the feature curve of the proximity sensor 126 corresponding to a distance of 0.5 mm to 1 mm from the detected target 124 is used, that is, a distance between the proximity sensor 126 in the disclosure and the measurement surface 1242 of the detected target 124 is controlled within this distance range.

In this region, the output of the proximity sensor 126 and the feature curve of the distance between the proximity sensor 126 and the detected target 124 have a positively correlated section. As the distance between the proximity sensor 126 and the detected target 124 increases, the light intensity value received by the proximity sensor 126 also increases to generate a larger output. Therefore, in this region, each output value of the proximity sensor 126 only corresponds to one distance value and vice versa. Therefore, according to the magnitude of the output of the proximity sensor 126 (that is, the measurement data D1), the orientation of the detected target 124 is deduced, and then the angle position of the rotation shaft 122 is determined.

In addition, to enhance the resolution ratio of the measurement data D1 outputted by the proximity sensor 126, a gray detected target 124 is used in an of the disclosure, including a gray measurement surface 1242. Compared with a white measurement surface 1242 with high reflectivity, the gray measurement surface 1242 used in this embodiment enlarges a difference of the light intensity value of the reflected light received by the optical receiver 1264 when the distance between the proximity sensor 126 and the detected target 124 is different, which is beneficial to improve sensing accuracy of the angle sensing device 120 in the disclosure.

In addition, as described above, the angle sensing device 120 in the disclosure mainly analyzes the light intensity value received by the proximity sensor 126 to determine the angle position of the rotation shaft 122 (especially the detected target 124 on the rotation shaft 122). The magnitude of the light intensity value received by the proximity sensor 126 is affected by the distance between the proximity sensor 126 and the measurement surface 1242 of the detected target 124. Therefore, the shape of the measurement surface 1242 of the detected target 124 has a significant impact on the sensing accuracy and sensing range of the angle sensing device 120 in the disclosure.

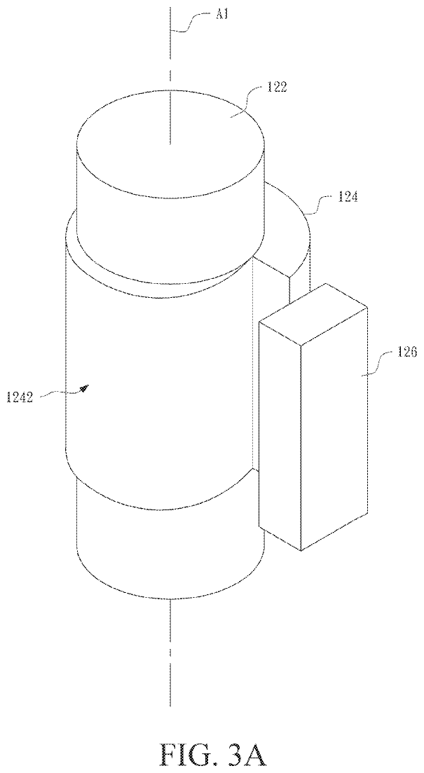

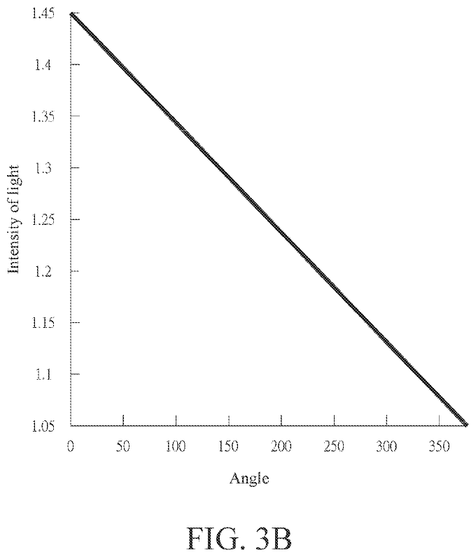

FIG. 3A is a schematic three-dimensional diagram of a detected target 124 according to an embodiment of the disclosure. The detected target 124 is the detected target shown in FIG. 1. FIG. 3B is a simulation result of a proximity sensor 126 detecting the detected target 124 in FIG. 3A at different angle positions. A horizontal axis in the figure represents an angle position of the detected target 124, and a vertical axis represents an intensity of light received by the proximity sensor 126. Values of the vertical axis do not have units, but only express relative magnitudes.

In an embodiment, as shown in FIG. 3A, the detected target 124 protrudes from the side surface 122a of the rotation shaft 122, and presents a spiral columnar structure. When viewed from the virtual axis A1 of the rotation shaft 122, an outer contour of a cross section of the detected target 124 along the radial direction of the rotation shaft 122 presents a spiral structure.

As shown in FIG. 3B, within a 360-degree rotation range, each angle position of the rotation shaft 122 (or the detected target 124) corresponds to a single light intensity value and vice versa. When an angle position of the measurement surface 1242 closest to the proximity sensor 126 is set to 0 degrees, as a rotation angle increases, a light intensity value measured by the proximity sensor 126 also increases synchronously.

A single proximity sensor 126 is used in the embodiment of FIG. 1 to detect the detected target 124 to generate the measurement data D1. In other embodiments, a plurality of proximity sensors 126 are also arranged around the rotation shaft 122 to detect the detected target 124 at the same time. The processing unit 140 further integrates the measurement data D1 of the proximity sensors 126 to estimate the angle position or rotation angle of the rotation shaft 122.

By using the plurality of proximity sensors 126, when an output value of a specific proximity sensor 126 fails to effectively reflect the orientation of the detected target 124, other proximity sensors 126 make up for its deficiency, so as to achieve accurate angle measurement.

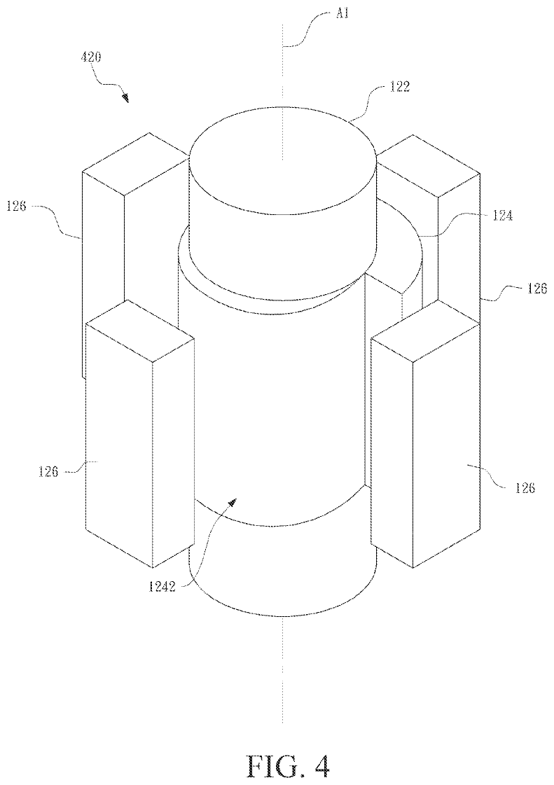

FIG. 4 is a schematic three-dimensional diagram of an angle sensing device 420 according to another embodiment of the disclosure.

As shown in the figure, in this embodiment, the angle sensing device 420 is arranged with four proximity sensors 126, and these proximity sensors 126 are equidistantly arranged around the rotation shaft 122 within a sensing range (that is, 360 degrees) of the angle sensing device 420 to generate measurement data D1. The measurement data D1 generated by these proximity sensors 126 is transmitted to the processing unit 140 shown in FIG. 1 for processing to obtain an angle value V1 through conversion.

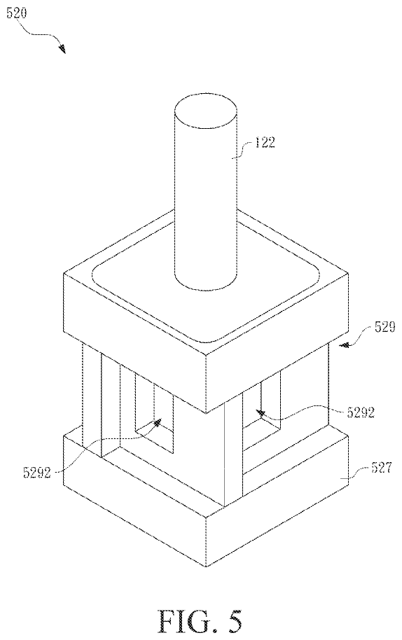

FIG. 5 is a schematic diagram of an angle sensing device 520 according to still another embodiment of the disclosure.

In order to locate the proximity sensor 126, in an embodiment, the angle sensing device 520 further includes a fixing frame 529. The fixing frame 529 is arranged on a base 527 and around the rotation shaft 122. The fixing frame 529 includes a plurality of fixing bases 5292, configured to arrange the proximity sensor 126. The fixing frame 529 in the figure is totally arranged with four fixing bases 5292, and at most four proximity sensor 126 are installed.

The above detected target 124 in FIG. 2 presents a spiral columnar structure. In a case that the position of the proximity sensor 126 is fixed, each angle position of the detected target 124 corresponds to a single distance value.

In an embodiment, in a case that an angle range to be measured by the plurality of proximity sensors 126 or angle sensing devices 120 is less than 360 degrees, other types of detected targets 124 are also used.

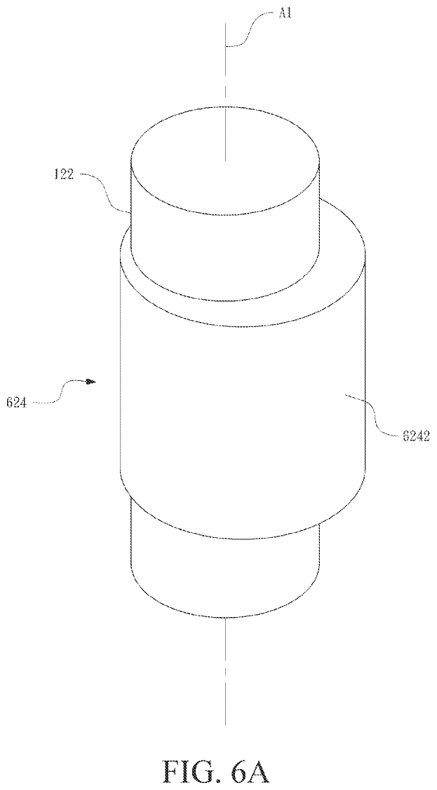

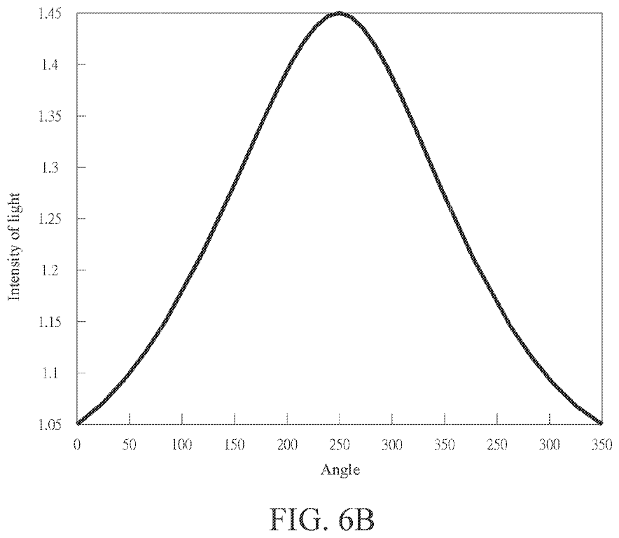

FIG. 6A is a schematic diagram of a detected target 624 according to another embodiment of the disclosure. FIG. 6B is a simulation result of a proximity sensor 126 detecting the detected target 624 in FIG. 6A at different angle positions. A horizontal axis in the figure represents an angle position of the detected target 624, and a vertical axis represents an intensity of light received by the proximity sensor 126. Values of the vertical axis do not have units, but only express relative magnitudes.

Compared with the detected target 124 in FIG. 3A, the detected target 624 in this embodiment is an eccentric columnar structure. An outer contour of a cross section of the detected target 624 along a radial direction of the rotation shaft 122 presents an eccentric circle. Other eccentric columnar structures, such as an eccentric elliptic columnar structure, are also applicable to the disclosure.

For the eccentric cylindrical structure of this embodiment, as shown in FIG. 6B, when an angle position of the measurement surface 6242 closest to the proximity sensor 126 is set to 0 degrees, a 360-degree rotation range is divided into a front half part (that is, 0 degrees to 180 degrees) and a rear half part (that is, 180 degrees to 360 degrees). In the front half part, as the rotation angle increases, the light intensity value measured by the proximity sensor 126 also increases synchronously, and each angle position of the rotation shaft 122 (or the detected target 624) corresponds to a single light intensity value and vice versa. In the rear half part, as the rotation angle increases, the light intensity value measured by the proximity sensor 126 also decreases synchronously, and each angle position of the rotation shaft 122 (or the detected target 624) corresponds to a single light intensity value and vice versa.

Therefore, the detected target 624 is applicable to a case that an angle range to be measured by the angle sensing device 120 is less than 180 degrees, without using a plurality of proximity sensors 126. However, this does not mean that the detected target 624 is not applicable to a case that the angle range to be measured by the angle sensing device 120 is greater than 180 degrees. When the plurality of proximity sensors 126 is used for simultaneous measurement, the detected target 624 is also applicable to the case that the angle range to be measured is greater than 180 degrees, and good measurement accuracy is also maintained.

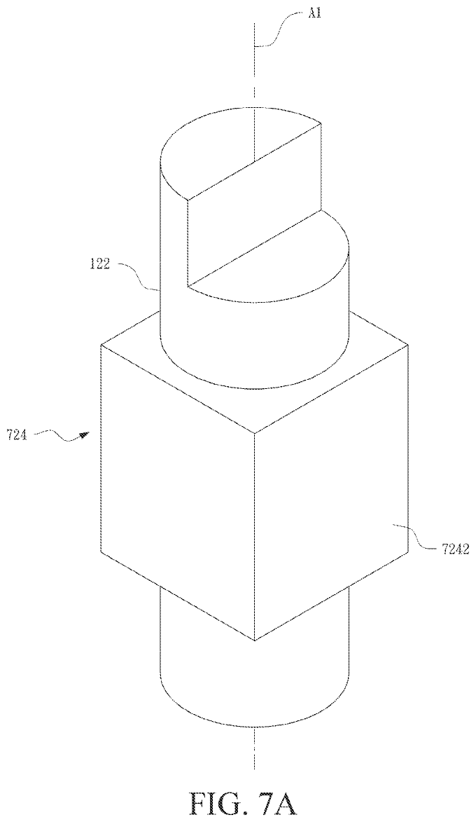

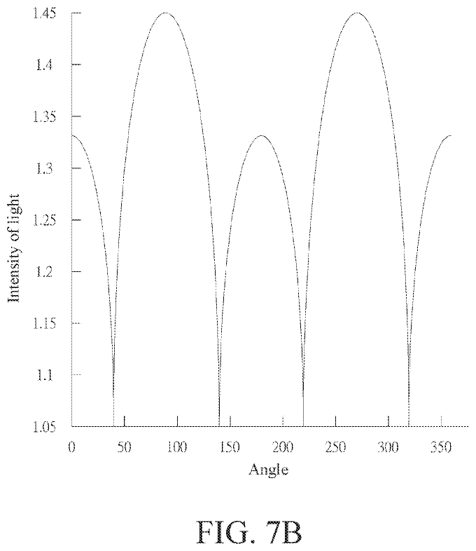

FIG. 7A is a schematic three-dimensional diagram of a detected target 724 according to still another embodiment of the disclosure. FIG. 7B is a simulation result of a proximity sensor 126 detecting the detected target 724 in FIG. 7A at different angle positions. A horizontal axis in the figure represents an angle position of the detected target 724, and a vertical axis represents an intensity of light received by the proximity sensor 126. Values of the vertical axis do not have units, but only express relative magnitudes.

Compared with the detected target 124 shown in FIG. 3A, in this embodiment, the detected target 724 is a regular quadrilateral columnar structure, and an outer contour of a cross section along the radial direction of the rotation shaft 122 presents a regular quadrangle, including four measurement surfaces 7242. Other regular polygonal columnar structures or asymmetric polygonal columnar structures, such as asymmetric regular quadrilateral columnar structure, are also applicable to the disclosure.

For the regular quadrilateral columnar structure of this embodiment, as shown in FIG. 7B, in a case that an angle position of the detected target 724 is set to 0 degrees when aligned with the proximity sensor 126, a 360-degree rotation range is divided into eight parts, and the angle range of each part is 45 degrees. In the each part, the light intensity value measured by the proximity sensor 126 increases or decreases synchronously as the rotation angle increases, and each angle position of the rotation shaft 122 (or the detected target 724) corresponds to a single light intensity value.

Therefore, the detected target 724 is applicable to a case that an angle range to be measured by the angle sensing device 120 is less than 45 degrees, without using a plurality of proximity sensors 126. However, this does not mean that the detected target 724 is not applicable to a case that the angle range to be measured by the angle sensing device 120 is greater than 90 degrees. When the plurality of proximity sensors 126 is used for simultaneous measurement, the detected target 724 is also applicable to the case that the angle range to be measured is greater than 45 degrees, and good measurement accuracy is also maintained.

To sum up, the angle sensing device 120 in the disclosure uses the proximity sensor 126 and the specially shaped detected targets 124, 624, and 724 to achieve the effect that optical angle detection is less susceptible to external magnetic interference. In addition, the angle sensing device 120 in the disclosure uses a positively correlated region in the feature curve of the proximity sensor 126 ranging from 0.5 mm to 1.5 mm, to generate the measurement data D1 to determine the angle position of the rotation shaft, and the small distance range facilitates high-accuracy measurement in a small space. In addition, in the disclosure, the processing unit 140 matched with the angle sensing device 120 also learns through a neural network to generate correction parameters to correct errors in a conversion process of the processing unit 140 to improve sensing accuracy. Therefore, the angle sensing device 120 provided in the disclosure achieves high-accuracy measurement in a small space, and overcomes the fact that the conventional inductive angle sensor is easily affected by external magnetic interference to affect the feedback control accuracy, and the optical angle sensor has the problem of poor sensing accuracy.

The above is merely exemplary embodiments of the disclosure, and does not constitute any limitation on the disclosure. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. An angle sensing device, comprising:
a base;
a rotation shaft, rotatably arranged on the base, wherein the rotation shaft comprises a side surface and a virtual axis;
a detected target, arranged on the side surface, wherein an outer contour of a cross section of the detected target along a radial direction of the rotation shaft comprises a first detected position and a second detected position, and a distance of the first detected position with respect to the virtual axis is different from that of the second detected position with respect to the virtual axis; and
a proximity sensor, fixedly arranged on the base and facing the detected target, wherein
when the detected target rotates together with the rotation shaft, the proximity sensor emits light toward the detected target and detects reflected light from the outer contour of the detected target to generate measurement data.

2. The angle sensing device according to claim 1, wherein a plurality of proximity sensors is provided.

3. The angle sensing device according to claim 2, wherein the proximity sensors are equidistantly arranged around the rotation shaft.

4. The angle sensing device according to claim 2, wherein the angle sensing device is adapted to be coupled to a processing unit, wherein the processing unit obtains an angle value through conversion according to the measurement data generated by the proximity sensor.

5. The angle sensing device according to claim 1, wherein the proximity sensor comprises a light source and an optical receiver, the light source emits the light toward the detected target, and the optical receiver detects the reflected light from the outer contour of the detected target, and generates the measurement data according to a light intensity value of the received reflected light.

6. The angle sensing device according to claim 5, wherein the light source is an infrared light source, the detected target comprises a gray measurement surface, and the light source projects the light toward the gray measurement surface.

7. The angle sensing device according to claim 6, wherein the light source and the optical receiver are arranged along a vertical direction, and the vertical direction is parallel to the virtual axis of the rotation shaft.

8. The angle sensing device according to claim 1, wherein a distance between the proximity sensor and the detected target ranges from 0.5 mm to 1 mm.

9. The angle sensing device according to claim 1, wherein the detected target is an eccentric columnar structure, a regular polygonal columnar structure, an asymmetric polygonal columnar structure, or a spiral columnar structure.

10. The angle sensing device according to claim 1, further comprising a fixing frame, arranged on the base and around the rotation shaft, wherein the fixing frame comprises at least one fixing base, configured to arrange the proximity sensor.

11. The angle sensing device according to claim 1, wherein the detected target protrudes from the side surface.

12. An angle sensing system, comprising:
an angle sensing device, comprising:
a base;
a rotation shaft, rotatably arranged on the base, wherein the rotation shaft comprises a side surface and a virtual axis;
a detected target, arranged on the side surface, wherein an outer contour of a cross section of the detected target along a radial direction of the rotation shaft comprises a first detected position and a second detected position, and a distance of the first detected position with respect to the virtual axis is different from that of the second detected position with respect to the virtual axis; and
a proximity sensor, fixedly arranged on the base and facing the detected target, wherein
when the detected target rotates together with the rotation shaft, the proximity sensor emits light toward the detected target and detects reflected light from the outer contour of the detected target to generate measurement data; and
a processing unit, electrically coupled to the angle sensing device for obtaining an angle value through conversion according to the measurement data generated by the proximity sensor.
